(19) United States
(12) Patent Application Publication
(10) Pub. No.: US 2021/0325738 A1
(43) Pub. Date: Oct. 21, 2021

(54) DISPLAY PANEL AND DISPLAY DEVICE

(71) Applicant: TCL CHINA STAR OPTOELECTRONICS TECHNOLOGY CO., LTD., Shenzhen, Guangdong (CN)

(72) Inventors: Zhibo CAO, Shenzhen (CN); Guo ZHAO, Shenzhen (CN)

(73) Assignee: TCL China Star Optoelectronics Technology Co., Ltd., Shenzhen, Guangdong (CN)

(21) Appl. No.: 16/627,822

(22) PCT Filed: Dec. 18, 2019
(86) PCT No.: PCT/CN2019/126347

§ 371 Date: Dec. 31, 2019

(30) Foreign Application Priority Data
Dec. 10, 2019 (CN) 201911255424.1

(51) Int. Cl. G02F 1/1343

(52) U.S. Cl. CPC G02F 1/134309

(57) ABSTRACT

A display panel and a display device are provided. The display panel includes a first electrode layer, a second electrode layer, and a liquid crystal layer provided between the first electrode layer and the second electrode layer. The liquid crystal layer includes liquid crystal molecules, and the second electrode layer includes a first area disposed corresponding to a non-display area of the display panel. A voltage applied to the first electrode layer is equal to a voltage applied to the first area of the second electrode layer, so that an orientation of the liquid crystal molecules located between the first electrode layer and the first area of the second electrode layer is not changed.

### FIELD OF INVENTION

The present disclosure relates to fields of display technology, in particular to the manufacture of display devices, and specifically relates to display panels and display devices.

### BACKGROUND OF DISCLOSURE

Liquid crystal displays (LCDs) can display an image by switching the liquid crystals to modulate a light field intensity of a backlight, and have the characteristics, such as thin body, energy conservation, high resolution, etc.

Currently, for some abnormal shape screens, as shown in FIG. 1, because a shape of a frame 01 is irregular, pixels 03 located in an edge area 02 near the frame 01 are generally configured to be a jaggies. Although the jaggies in the image can be attenuated after image processing, the jaggies phenomenon is relatively visible upon displaying the image, which reduces the image quality.

Therefore, it is necessary to provide a display panel and a display device that can improve the jaggies phenomenon of pixels in the edge area upon displaying an image, so as to improve the image quality.

### SUMMARY OF INVENTION

### Technical Problem

An object of the present disclosure are to provide a display panel and a display device. A voltage applied to a first area of a second electrode layer corresponding to the non-display area is equal to a voltage applied to a first electrode layer, so that an orientation of liquid crystal molecules located between the first electrode layer and the first area of the second electrode layer is not changed, thereby solving a problem of the existing abnormal shape screens that the jaggies is relatively visible in an edge area of a screen when displaying an image.

### Technical Solution

An embodiment of the present disclosure provides a display panel, including: a display area and a non-display area, and the display panel further including: a first electrode layer, a liquid crystal layer, and a second electrode layer.

The liquid crystal layer is disposed between the first electrode layer and the second electrode layer, and the liquid crystal layer has a plurality of liquid crystal molecules.

The second electrode layer and the first electrode layer are disposed opposite to each other, the second electrode layer has a first area which is disposed corresponding to the non-display area, and a voltage applied to the first electrode layer is equal to a voltage applied to the first area of the second electrode layer, so that an orientation of the liquid crystal molecules located between the first electrode layer and the first area of the second electrode layer is not changed.

In an embodiment of the present disclosure, the second electrode layer includes:

a plurality of data electrodes disposed in parallel to each other; and

a plurality of pixel units disposed between two adjacent of the data electrodes.

In an embodiment of the present disclosure, the pixel units include a plurality of target pixel units partially located in the first area, the target pixel unit including a first target sub-area located in the first area, and a voltage applied to the first target sub-area of the target pixel unit is equal to the voltage applied to the first electrode layer.

In an embodiment of the present disclosure, the second electrode layer further includes a second area disposed corresponding to a partial area of the display area.

The target pixel unit further includes a second target sub-area located in the second area, wherein a voltage applied to the second target sub-area of the target pixel unit is equal to the voltage applied to the first electrode layer.

The target pixel unit includes a plurality of target sub-pixels, and, an overlap area of at least one of the target sub-pixels and the second target sub-area is zero in each of the target pixel units.

A proportion of each of the target sub-pixels to a total area of the first target sub-area and the second target sub-area in the same target pixel unit is same.

In an embodiment of the present disclosure, the second area is disposed adjacent to the first area, and the second electrode layer further includes a third area, and the third area is an area other than the first area and the second area in the second electrode layer.

The target pixel unit further includes a third target sub-area located in the third area, wherein a voltage applied to the third target sub-area of the target pixel unit is different from the voltage applied to the first electrode layer.

In an embodiment of the present disclosure, the second electrode layer further includes a fourth area disposed opposite to the non-display area.

The target pixel unit further includes a fourth target sub-area located in the fourth area, wherein a voltage applied to the fourth target sub-area of the target pixel unit is different from the voltage applied to the first electrode layer.

In an embodiment of the present disclosure, a voltage applied to the data electrode is equal to the voltage applied to the first electrode layer.

In an embodiment of the present disclosure, a material of the data electrodes and a material of the pixel units are the same.

In an embodiment of the present disclosure, the data electrodes and the pixel units are prepared in a same layer

In an embodiment of the present disclosure, a material of the first electrode layer and a material of the second electrode layer are the same.

An embodiment of the present disclosure further provides a display device, including a display panel, and the display panel including: a display area and a non-display area, and the display panel further including: a first electrode layer, a liquid crystal layer, and a second electrode layer.

The liquid crystal layer is disposed between the first electrode layer and the second electrode layer, and the liquid crystal layer has a plurality of liquid crystal molecules.

The second electrode layer and the first electrode layer are disposed opposite to each other, and the second electrode layer has a first area which is disposed corresponding to the non-display area, and a voltage applied to the first electrode layer is equal to a voltage applied to the first area of the second electrode layer, so that an orientation of the liquid crystal molecules located between the first electrode layer and the first area of the second electrode layer is not changed.

In an embodiment of the present disclosure, the second electrode layer includes:

a plurality of data electrodes disposed in parallel to each other; and

a plurality of pixel units disposed between two adjacent of the data electrodes.

In an embodiment of the present disclosure, the pixel units include a plurality of target pixel units partially located in the first area, the target pixel unit including a first target sub-area located in the first area, and a voltage applied to the first target sub-area of the target pixel unit is equal to the voltage applied to the first electrode layer.

In an embodiment of the present disclosure, the second electrode layer further includes a second area disposed corresponding to a partial area of the display area.

The target pixel unit further includes a second target sub-area located in the second area, wherein a voltage applied to the second target sub-area of the target pixel unit is equal to the voltage applied to the first electrode layer,

The target pixel unit includes a plurality of target sub-pixels, and, an overlap area of at least one of the target sub-pixels and the second target sub-area is zero in each of the target pixel units.

A proportion of each of the target sub-pixels to a total area of the first target sub-area and the second target sub-area in the same target pixel unit is same.

In an embodiment of the present disclosure, the second area is disposed adjacent to the first area, and the second electrode layer further includes a third area, and the third area is an area other than the first area and the second area in the second electrode layer.

The target pixel unit further includes a third target sub-area located in the third area, wherein a voltage applied to the third target sub-area of the target pixel unit is different from the voltage applied to the first electrode layer.

In an embodiment of the present disclosure, the second electrode layer further includes a fourth area disposed opposite to the non-display area.

The target pixel unit further includes a fourth target sub-area located in the fourth area, wherein a voltage applied to the fourth target sub-area of the target pixel unit is different from the voltage applied to the first electrode layer.

In an embodiment of the present disclosure, a voltage applied to the data electrode is equal to the voltage applied to the first electrode layer.

In an embodiment of the present disclosure, a material of the data electrodes and a material of the pixel units are the same.

In an embodiment of the present disclosure, wherein a material of the first electrode layer and a material of the second electrode layer are the same.

In an embodiment of the present disclosure, a material of the first electrode layer and a material of the second electrode layer are the same.

Beneficial effect: The present disclosure provides a display panel and a display device. The display panel includes a first electrode layer, a second electrode layer, and a liquid crystal layer. An orientation of the liquid crystal molecules located between the first electrode layer and the first area of the second electrode layer is not changed by configuring a voltage applied to the first area of the second electrode layer corresponding to a non-display area and a voltage applied to the first electrode layer to be a same value, thereby improving the jaggies in the edge area of a screen upon displaying an image, so as to enhance the image quality of the display panel and the display device.

### DRAWINGS

The disclosure is further described below with reference to the accompanying drawings. It should be noted that the drawings in the following description are only used to explain some embodiments of the present disclosure. Those skilled in the art may also obtain other drawings based on these drawings without any creative efforts.

FIG. 1 is a schematic view of an image display in the prior art.

FIG. 2 is a schematic cross-sectional view of a display panel according to an embodiment of the present disclosure.

FIG. 3 is a schematic top view of a second electrode layer of a display panel according to an embodiment of the present disclosure.

FIG. 4 is a schematic top view of a second electrode layer of another display panel according to an embodiment of the present disclosure.

FIG. 5 is a schematic top view of a target pixel unit of a display panel according to an embodiment of the present disclosure.

FIG. 6 is a schematic top view of a second electrode layer of yet another display panel according to an embodiment of the present disclosure.

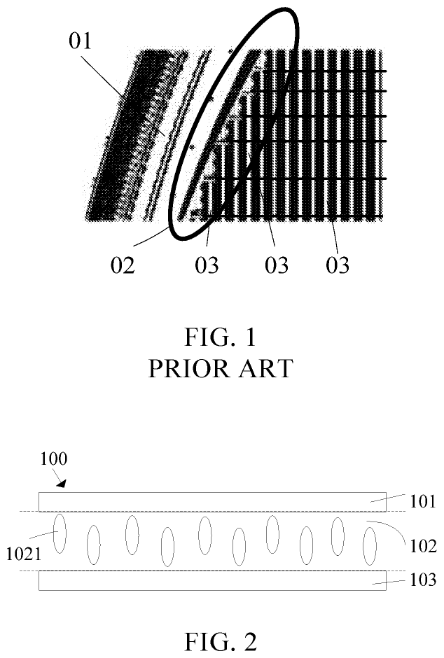

### DETAILED DESCRIPTION OF EMBODIMENTS

The technical scheme of the embodiment of the disclosure will be described clearly and completely below in combination with the accompanying drawings of the embodiment of the disclosure. It is apparent that the described embodiments are only part of the embodiments of the disclosure, not all of them. Based on the embodiments of the disclosure, other embodiments obtained by those skilled in the art without any creative work all belong to the protection scope of the disclosure.

In the description of the disclosure, it is to be understood that the direction or position relationship indicated by the terms “up”, “down”, etc. is based on the direction or position relationship shown in the accompanying drawings, the term “up” only means above the object, specifically referring to the over, obliquely above and on a upper surface, as long as it is above the level of the object. The above orientations or positional relationships are merely for the convenience of describing the disclosure and simplifying the description, and do not indicate or imply that the device or element referred to must have a specific orientation, be constructed and operate in a specific orientation, and therefore cannot be understood as a limitation on the present disclosure.

In addition, it should be noted that the drawings only provide structures and/or steps that are closely related to the disclosure, and omit some details that are little interest to the disclosure. The purpose is to simplify the drawings and make the disclosure clear. It does not mean that the device and/or method in practice is exactly the same as the drawing, and is not a limitation of the device and/or method in practice. The same reference numerals indicate the same structures throughout.

The term “embodiment” herein means that a particular feature, structure, or characteristic described in connection with the embodiment may be included in at least one embodiment of the disclosure. The presence of the phrase at various locations in the specification does not necessarily mean the same embodiment, nor is it an independent or alternative embodiment mutually exclusive with other embodiments. It is explicitly and implicitly understood by those skilled in the art that the embodiments described herein may be combined with other embodiments.

The present disclosure provides a display device, which includes a display panel as shown in FIGS. 2-6.

As shown in FIG. 2, the display panel 100 includes a first electrode layer 101, a liquid crystal layer 102, and a second electrode layer 103.

It can be understood that the display panel 100 may be divided into a display area and a non-display area.

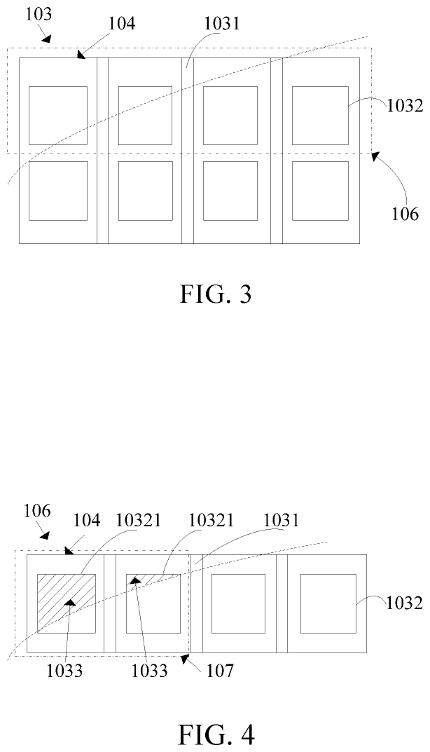

The liquid crystal layer 102 is disposed between the first electrode layer 101 and the second electrode layer 103. The liquid crystal layer 102 includes a plurality of liquid crystal molecules 1021. The second electrode layer 103 and the first electrode layer 101 are disposed opposite each other. As shown in FIG. 3, the second electrode layer 103 includes a first area 104. The first area 104 corresponds to the non-display area, and a voltage applied to the first electrode layer 101 is equal to a voltage applied to the first area 104 of the second electrode layer 103, so that an orientation of the liquid crystal molecules 1021 located between the first electrode layer 101 and the first area 104 of the second electrode layer 103 is not changed.

It should be noted that when there is a voltage difference between a upper side and a lower side of the liquid crystal molecules 1021, the liquid crystal molecules 1021 can be rotated, so that the light emitted by a backlight module of the display panel 100 passes through the liquid crystal layer 102. When there is no voltage difference between the upper side and the lower side of the liquid crystal molecules 1021, an orientation of the liquid crystal molecules 1021 is not changed, so that the light emitted by the backlight module of the display panel 100 does not pass through the liquid crystal layer 102 and emit out.

It can be understood that, because the voltage applied to the first electrode layer 101 is equal to the voltage applied to the first area 104 of the second electrode layer 103, when the display panel 100 is displaying images, it can be guaranteed that the orientation of the liquid crystal molecules 102 is not changed, so that no light passes through the non-display area, thereby displaying no image.

In an embodiment, the first electrode layer 101 may be a whole piece of conductive material. That is, voltage values of any area in the first electrode layer 101 may be equal.

In an embodiment, the first area 104 of the second electrode layer 103 may be directly prepared from a conductive material without being subjected to a patterning process.

In an embodiment, as shown in FIG. 3, the second electrode layer 103 includes a plurality of data electrodes 1031 and a plurality of pixel units 1032. An area 106 is defined by a same row of the pixel units 1032 and a surrounding association area.

The data electrodes 1031 are disposed in parallel to each other, and the pixel units 1032 are disposed between two adjacent of the data electrodes 1031. Furthermore, multiple of the data electrodes 1031 may be disposed between two adjacent of the data electrodes 1031, and the multiple data electrodes 1031 between the two adjacent data electrodes 1031 may be provided in an extending direction along the corresponding data electrode 1031.

In an embodiment, as shown in FIG. 4, in the area 106, the pixel units 1032 includes a plurality of target pixel units 10321, and the target pixel units 10321 are partially located in the first area 104. The target pixel unit 10321 includes a first target sub-area 1033. The first target sub-area 1033 is located in the first area 104. A voltage applied to the first target sub-area 1033 of the target pixel unit 10321 is equal to the voltage applied to the first electrode layer 101. An area 107 is defined by a same row of the target pixel units 10321 and a surrounding association area.

It can be understood that, because the first target sub-area 1033 is disposed in the first area 104, and, that is, corresponds to the non-display area of the display panel 100, a voltage of the first target sub-area 1033 and the voltage of the first electrode layer 101 is configured to be equal, so that the orientation of the liquid crystal molecules 1021 between the first target sub-area 1033 and the first electrode layer 101 is not changed, so that no light can pass between the first target sub-area 1033 and the first electrode layer 101, so that no image is displayed.

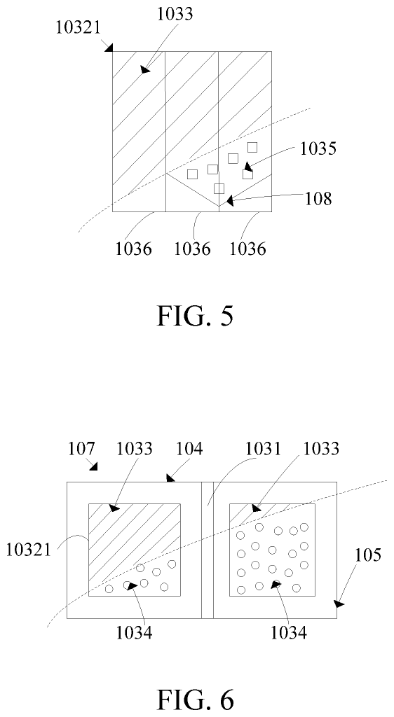

In an embodiment, as shown in FIG. 5, the second electrode layer 103 further includes a second area 108, and the second area 108 is disposed to correspond to a partial area of the display area. The target pixel unit 10321 further includes a second target sub-area 1035. The second target sub-area 1035 is located in the second area 105 and a voltage applied to the second target sub-area 1035 of the target pixel unit 10321 is equal to the voltage applied to the first electrode layer 101.

Specifically, the target pixel unit 10321 includes a plurality of target sub-pixels 1036. In each of the target pixel units 10321, an overlapping area of at least one of the target sub-pixels 1036 and the second target sub-area 1035 is zero in each of the target pixel units 10321. The target sub-pixel 1036 may be a red sub-pixel, a green sub-pixel, or a blue sub-pixel.

For example, an overlapping area of the leftmost target sub-pixel 1036 in the target pixel unit 10321 and the second target sub-area 1035 may be zero. An overlapping area of the other target sub-pixel 1036 in the target pixel unit 10321 and the second target sub-area 1035 may not be zero.

Furthermore, a proportion of each of the target sub-pixels 1036 to a total area of the first target sub-area 1033 and the second target sub-area 1035 in the same target pixel unit 10321 is same. For example, a proportion of an area of the first target sub-area 1033 in a leftmost target sub-pixel 1036 of the target pixel unit 10321 is equal to a proportion of a total area of the first target sub-area 1033 and the second target sub-area 1035 in a middle or a right target sub-pixel 1036 of the target pixel unit 10321.

It should be noted that, for each of the target pixel units 10321, in the target sub-pixels 1036, a target sub-pixel 1036 having a highest proportion of the first target sub-region 1033 can be determined, and the proportion of this first target sub-area 1033 to the target sub-pixel 1036 is set as a standard proportion. In each of the other target sub-pixels 1036, a corresponding sub-area occupied by a corresponding second target sub-area 1035 is selected to form the second target sub-area 1035, to ensure that the proportion of each of the target sub-pixels 1036 to a total area of the first target sub-area 1033 plus the second target sub-area 1035 in the same target pixel unit 10321 is same.

It can be understood that, in a case of ensuring that the voltage applied to the first target sub-region 1033 of the target pixel unit 10321 is equal to the voltage applied to the first electrode layer 101, so that the voltage applied to the second target sub-region 1035 is equal to the voltage applied to the first electrode layer 101. That is, for the same target pixel unit 10321, when an image is displayed, the pixel area proportion used for image display in each of the target sub-pixels 1036 is the same. By making sub-pixels with different colors have the same contribution proportion area to the corresponding target pixel unit 10321, the problem of color cast can be further resolved.

In an embodiment, the second area 108 may be disposed adjacent to the first area 104. Furthermore, the second electrode layer 103 further includes a third area, and the third area is an area other than the first area 104 and the second area 108 in the second electrode layer 103. The target pixel unit 10321 further includes a third target sub-area, the third target sub-area is located in the third area, and a voltage applied to the third target sub-area of the target pixel unit 10321 is different from the voltage applied to the first electrode layer 101.

In an embodiment, as shown in FIG. 6, in the area 107, the second electrode layer 102 further includes a fourth area 105, and the fourth area 105 is disposed opposite the display area. Furthermore, the target pixel unit 10321 further includes a fourth target sub-area 1034, the fourth target sub-area 1034 is located in the fourth area 105, and the first target sub-area 1033 and the corresponding fourth target sub-area 1034 may constitute a corresponding complete target pixel unit 10321. A voltage applied to the third target sub-area 1034 of the target pixel unit 10321 is different from the voltage applied to the first electrode layer 101.

It can be understood that, for each of the target pixel units 10321, the voltage of the first target sub-area 1033 is set to be equal to the voltage of the first electrode layer 101, and the voltage of the fourth target sub-area 1034 is set to be different from the voltage of the first electrode layer 101, so an orientation of the liquid crystal molecules 1021 located in the non-display area of the target pixel unit 10321 is not changed, and an orientation of the liquid crystal molecules 1021 located in the display area of the target pixel unit 10321 is changed; so that the pixels in the non-display area may not emit light, and the pixels in the display area may emit light upon displaying the image, which has a relatively visible light emission boundary, which improves the jaggies phenomenon existing in the art.

In an embodiment, as shown in FIGS. 3-5, a voltage applied to the data electrode 1031 is equal to the voltage applied to the first electrode layer 101.

It can be understood that the voltage values in any area of the first electrode layer 101 are equal, and, that is, the voltage difference between different areas in the second electrode layer 103 and the first electrode layer 101 may change the orientation of the liquid crystal molecules 1021 located in corresponding areas between the first electrode layer 101 and the second electrode layer 103, so that light is emitted out. The voltage values of the pixel units 1032 located on both sides of the data electrode 1031 are generally different, and the corresponding liquid crystal molecules are tilted to different degrees. In order to prevent the light corresponding to the two pixel units 1032 from interfering with each other, the data electrode 1031 may be provided in an area between the two pixel units 1032, and the voltage of the data electrode 1031 and the voltage of the first electrode layer 101 may be set to the same value, so that an orientation of the liquid crystal molecules in the area between the two pixel units 1032 is not changed, so the light corresponding to the two pixel units 1032 is prevented from passing through the tilted liquid crystal molecules in the area between the two pixel units 1032, which solves the light leakage problem in the two adjacent pixel units.

In one embodiment, a material of the data electrodes 1031 and a material of the pixel units 1032 are the same.

It should be noted that the light leakage problem is solved by applying the same voltage to the data electrode 1031 as the voltage applied to the first electrode layer 101. Therefore, the data electrode 1031 and the pixel unit 1032 may be made of the same material. The same material should be a conductive material. For example, material of the data electrodes 1031 and the pixel units 1032 may include a transparent indium tin oxide. It can be understood that because the material of the data electrodes 1031 and the material of the pixel units 1032 are the same, the data electrodes 1031 of the second electrode layer 103 and the pixel units 1032 of the second electrode layer 103 are prepared in a same layer. For example, both can be formed by a patterning process at the same time, which simplifies the manufacturing process of the display panel.

In one embodiment, a material of the first electrode layer 101 and a material of the second electrode layer 103 are the same.

The first electrode layer 101 and the second electrode layer 103 may be plated with an oxide indium tin film by using various methods such as sputter, evaporation, etc. to prepared on a sodium-calcium-based or borosilicate substrate glass base.

The structures of a display panel and a display device including the display panel according to the embodiments of the present disclosure have been described in detail above. Specific embodiments used herein are to explain the principle and implementation of the present disclosure. The description is only used to help understand the technical solution of the present disclosure and its core concept. Those skilled in the art should understand that they can still modify the technical solutions described in the foregoing embodiments, or equivalently replace some of the technical features. These modifications or replacements do not make the essence of the corresponding technical solutions outside the scope of the technical solutions of the embodiments of the present disclosure.

1. A display panel, comprising:
a display area and a non-display area, and
the display panel further comprising:
a first electrode layer, a liquid crystal layer, and a second electrode layer,
wherein the liquid crystal layer is disposed between the first electrode layer and the second electrode layer, and the liquid crystal layer has a plurality of liquid crystal molecules; and
wherein the second electrode layer and the first electrode layer are disposed opposite to each other, the second electrode layer has a first area which is disposed corresponding to the non-display area, and a voltage applied to the first electrode layer is equal to a voltage applied to the first area of the second electrode layer, so that an orientation of the liquid crystal molecules located between the first electrode layer and the first area of the second electrode layer is not changed.

2. The display panel according to claim 1, wherein the second electrode layer comprises:
a plurality of data electrodes disposed in parallel to each other; and
a plurality of pixel units disposed between two adjacent of the data electrodes.

3. The display panel according to claim 2, wherein the pixel units comprise a plurality of target pixel units partially located in the first area, the target pixel unit comprising a first target sub-area located in the first area, and a voltage applied to the first target sub-area of the target pixel unit is equal to the voltage applied to the first electrode layer.

4. The display panel according to claim 3, wherein the second electrode layer further comprises a second area disposed corresponding to a partial area of the display area; and
the target pixel unit further comprises a second target sub-area located in the second area,
wherein a voltage applied to the second target sub-area of the target pixel unit is equal to the voltage applied to the first electrode layer,
the target pixel unit comprises a plurality of target sub-pixels, and, an overlap area of at least one of the target sub-pixels and the second target sub-area is zero in each of the target pixel units; and
a proportion of each of the target sub-pixels to a total area of the first target sub-area and the second target sub-area in the same target pixel unit is same.

5. The display panel according to claim 4, wherein the second area is disposed adjacent to the first area, and the second electrode layer further comprises a third area, and the third area is an area other than the first area and the second area in the second electrode layer; and
the target pixel unit further comprises a third target sub-area located in the third area, wherein a voltage applied to the third target sub-area of the target pixel unit is different from the voltage applied to the first electrode layer.

6. The display panel according to claim 3, wherein the second electrode layer further comprises a fourth area disposed opposite to the non-display area; and
the target pixel unit further comprises a fourth target sub-area located in the fourth area, wherein a voltage applied to the fourth target sub-area of the target pixel unit is different from the voltage applied to the first electrode layer.

7. The display panel according to claim 2, wherein a voltage applied to the data electrode is equal to the voltage applied to the first electrode layer.

8. The display panel according to claim 2, wherein a material of the data electrodes and a material of the pixel units are the same.

9. The display panel according to claim 8, wherein the data electrodes and the pixel units are prepared in a same layer

10. The display panel according to claim 1, wherein a material of the first electrode layer and a material of the second electrode layer are the same.

11. A display device, comprising a display panel, and the display panel comprising:
a display area and a non-display area, and
the display panel further comprising:
a first electrode layer, a liquid crystal layer, and a second electrode layer,
wherein the liquid crystal layer is disposed between the first electrode layer and the second electrode layer, and the liquid crystal layer has a plurality of liquid crystal molecules; and
wherein the second electrode layer and the first electrode layer are disposed opposite to each other, and the second electrode layer has a first area which is disposed corresponding to the non-display area, and a voltage applied to the first electrode layer is equal to a voltage applied to the first area of the second electrode layer, so that an orientation of the liquid crystal molecules located between the first electrode layer and the first area of the second electrode layer is not changed.

12. The display device according to claim 11, wherein the second electrode layer comprises:
a plurality of data electrodes disposed in parallel to each other; and
a plurality of pixel units disposed between two adjacent of the data electrodes.

13. The display device according to claim 12, wherein the pixel units comprise a plurality of target pixel units partially located in the first area, the target pixel unit comprising a first target sub-area located in the first area, and a voltage applied to the first target sub-area of the target pixel unit is equal to the voltage applied to the first electrode layer.

14. The display device according to claim 13, wherein the second electrode layer further comprises a second area disposed corresponding to a partial area of the display area; and
the target pixel unit further comprises a second target sub-area located in the second area, wherein a voltage applied to the second target sub-area of the target pixel unit is equal to the voltage applied to the first electrode layer,
wherein the target pixel unit comprises a plurality of target sub-pixels, and, an overlap area of at least one of the target sub-pixels and the second target sub-area is zero in each of the target pixel units; and
a proportion of each of the target sub-pixels to a total area of the first target sub-area and the second target sub-area in the same target pixel unit is same.

15. The display device according to claim 14, wherein the second area is disposed adjacent to the first area, and the second electrode layer further comprises a third area, and the third area is an area other than the first area and the second area in the second electrode layer; and
the target pixel unit further comprises a third target sub-area located in the third area, wherein a voltage applied to the third target sub-area of the target pixel unit is different from the voltage applied to the first electrode layer.

16. The display device according to claim 13, wherein the second electrode layer further comprises a fourth area disposed opposite to the non-display area; and
the target pixel unit further comprises a fourth target sub-area located in the fourth area, wherein a voltage applied to the fourth target sub-area of the target pixel unit is different from the voltage applied to the first electrode layer.

17. The display device according to claim 12, wherein a voltage applied to the data electrode is equal to the voltage applied to the first electrode layer.

18. The display device according to claim 12, wherein a material of the data electrodes and a material of the pixel units are the same.

19. The display device according to claim 18, wherein the data electrodes and the pixel units are prepared in a same layer.

20. The display device according to claim 11, wherein a material of the first electrode layer and a material of the second electrode layer are the same.
